(19) United States
(12) Patent Application Publication
(10) Pub. No.: US 2012/0287016 A1
(43) Pub. Date: Nov. 15, 2012

(54) Antenna and a Method of Manufacture Thereof

(75) Inventors: Beata Zalinska, South Yorkshire (GB); Oliver Paul Leisten, Northamptonshire (GB)

(73) Assignee: SARANTEL LIMITED, Wellingborough (GB)

(21) Appl. No.: 13/467,076

(22) Filed: May 9, 2012

Related U.S. Application Data
(60) Provisional application No. 61/509,468, filed on Jul. 19, 2011.

(30) Foreign Application Priority Data
May 13, 2011 (GB) 1108016.5

(51) Int. Cl. H01Q 1/36; H01P 11/00

(52) U.S. Cl. 343/895; 29/600

(57) ABSTRACT

A method of manufacturing a dielectrically loaded antenna having an operating frequency in excess of 200 MHz, the antenna having an electrically insulative core, the method including steps of: forming a first patterned layer of conductive material having a plurality of inner conductive tracks on at least one surface of the core of the antenna; depositing a layer of insulative material over at least a portion of the first layer of conductive material; and forming a second patterned layer of conductive material having a plurality of outer conductive tracks, at least partially overlapping the inner conductive tracks.

### CROSS-REFERENCE TO RELATED APPLICATION

This application claims the benefit of the filing date of U.S. Provisional Patent Application No. 61/509,468 filed on Jul. 19, 2011.

### BACKGROUND OF THE INVENTION

This invention relates to a dielectrically loaded antenna for operation at frequencies in excess of 200 MHz and a method of manufacture of such an antenna.

Dielectrically loaded antennas are disclosed in a number of patent publications of the present applicant, including GB 2292638 A, GB 2309592 A, GB 2310543 A, GB 2338605 A, GB 2346014 A, GB 2351850 A, GB 2367429 A and GB 2445478 A. Each of these antennas has at least one pair of diametrically opposed helical antenna elements which are plated on a substantially cylindrical electrically insulative core made of a material having a relative dielectric constant greater than five. The material of the core occupies the major part of the volume defined by the core outer surface. An axial bore extends through the core from one end face to an opposite end face and contains a coaxial feed structure that comprises an inner conductor surrounded by a shield conductor. At one end of the bore, the feed structure conductors are connected to respective antenna elements which have associated connection portions adjacent to the end of the bore. At the other end of the bore, the shield conductor is connected to a conductor which links the antenna elements and, in each of these examples, is in the form of a conductive sleeve encircling part of the core to form a balun. Each of the antenna elements terminates at a rim of the sleeve and then each follows a respective helical path from its connection to the feed structure.

It is an object of the invention to provide an improved dielectrically loaded antenna and method of manufacture thereof.

### BRIEF SUMMARY OF THE INVENTION

In accordance with a first aspect, the present invention provides a method of manufacturing a dielectrically loaded antenna having an operating frequency in excess of 200 MHz, the antenna having an electrically insulative core, the method comprising: forming a first patterned layer of conductive material having a plurality of inner conductive tracks on at least one surface of the core of the antenna; depositing a layer of insulative material over at least a portion of the first layer of conductive material; and forming a second patterned layer of conductive material having a plurality of outer conductive tracks, at least partially overlapping the inner conductive tracks.

Preferably, the inner and outer conductive tracks are formed as elongate conductive tracks. The inner and outer conductive tracks may be formed such that at least one of the outer tracks is in registry with a respective one of the inner conductive tracks. The insulative material may be deposited over the first layer of conductive material so as to electrically insulate at least one of said inner conductive tracks from a respective outer conductive track over at least a portion of their respective overlapping areas.

Preferably, the first layer of conductive material includes at least one inner coupling portion, electrically connected to said inner conductive tracks, said second layer of conductive material includes at least one outer coupling portion, electrically connected to said outer conductive tracks, overlaying and in registry with said at least one inner coupling portion, and said layer of insulative material is formed such that the at least one inner coupling portion and the at least one outer coupling portion are in electrical contact with each other.

Preferably, the method further comprises patterning the layer of insulative material to leave at least one intermediate portion of the said inner conductive tracks exposed, such that when the respective outer conductive tracks are formed over the inner conductive tracks, corresponding intermediate portions thereof are formed directly on the intermediate portions of the inner tracks to make electrical contact therewith.

The core may be cylindrical, and the inner and outer conductive tracks are formed as conductive tracks on a cylindrical outer surface of the core. The inner and outer conductive tracks may be formed as helical tracks.

The layer of insulative material may be deposited on said first conductive layer using electrophoretic deposition. The step of depositing the layer of insulative material may comprise placing said antenna in a colloid of said insulative material.

Preferably, the method further comprises: applying a layer of photo-processable resist over portions of the first conductive layer to define the portions of the first conductive layer over which the layer of insulative material is to be deposited, wherein the layer of insulative material is deposited over the first conductive layer on the portions of the first conductive layer where no photo-processable resist has been applied. The method may further comprise applying said photo-processable resist to said first layer of conductive material using electrophoretic deposition. The method may further comprise fixing said photo-processable resist over said portions of the first conductive layer using a laser light source, using a first mask, wherein the first mask defines the areas of the photo-processable resist to be fixed.

Preferably, the step of forming the first layer of conductive material includes: plating the core with said conductive material, and removing at least a portion of the conductive material, to leave the first patterned layer of conductive material. The method may further comprise applying a layer of photo-etch resist over portions of the plated core to define the first patterned layer of conductive material, wherein conductive material is removed from areas of the core where no photo-etch resist has been applied. The method may further comprise applying said photo-etch resist to said plated core using electrophoretic deposition. The method may further comprise fixing said photo-etch resist over said portions of the plated core, using a laser light source, using a second mask, wherein the second mask defines the areas of the photo-etch resist to be fixed.

Preferably, the step of forming the second layer of conductive material includes: plating the core with said conductive material, and removing at least a portion of the conductive material, to leave the second patterned layer of conductive material. The method may further comprise applying a layer of photo-etch resist over portions of the plated core to define the second patterned layer of conductive material, wherein conductive material is removed from areas of the core where no photo-etch resist has been applied. The method may further comprise applying said photo-etch resist to said plated core using electrophoretic deposition. The method may further comprise fixing said photo-etch resist over said portions of the plated core, using a laser light source, using a third mask, wherein the third mask defines the areas of the photo-etch resist to be fixed.

The masks may define elongate helical tracks, and the pitch angle of the helical tracks of the third mask may be less than the pitch angle of the helical tracks of the second mask.

The insulative material may be polyether ether ketone and the conductive material may be copper.

In a further aspect, the present invention provides an antenna formed in accordance with the above-defined method.

In a further aspect, the present invention provides a dielectrically loaded antenna having an operating frequency in excess of 200 MHz, the antenna having an electrically insulative core and an antenna element structure overlaying at least one surface of the core, the antenna element structure including a first patterned layer of conductive material having a plurality of inner conductive tracks, a layer of insulative material, deposited over at least a portion of the first layer of conductive material, and a second patterned layer of conductive material, having a plurality of outer conductive tracks, at least partially overlapping the inner conductive tracks.

Preferably, the inner and outer conductive tracks are coupled to a feed structure. The core may be an electrical insulator having a relative dielectric constant greater than 5. The core may be a cylinder and the inner and outer conductive tracks may be in the form of helical conductive tracks extending over a cylindrical surface of the core. The inner and outer conductive tracks may be equally spaced around the cylindrical surface of the core.

Preferably, the layer of insulative material is formed such that the inner conductive tracks are electrically insulated from respective outer conductive tracks along at least a portion of their overlapping areas. The layer of insulative material may be formed over said inner conductive tracks so as to include gaps at intermediate positions, allowing the inner and outer conductors to form electrical connections at said intermediate positions.

### BRIEF DESCRIPTION OF THE DRAWINGS

The invention will now be described by way of example with reference to the drawings, in which:

FIG. 1 is a perspective view of an antenna in accordance with an embodiment of the invention;

FIG. 2 is a cross section of a feed structure for use with an antenna in accordance with an embodiment of the invention;

FIG. 3 is a cross section of a portion of the feed structure shown in FIG. 2;

FIGS. 4A to 4C are views of insulative and conductive layers of a board of the feed structure shown in FIG. 2;

FIG. 5 is a flow chart showing a manufacturing process in accordance with an embodiment of the present invention;

FIG. 6 is a flow chart showing further details of the manufacturing process shown in FIG. 5;

FIG. 7 shows a mask for use with the process described in connection with FIG. 6;

FIG. 8 is a flow chart showing further details of the manufacturing process shown in FIG. 5;

FIG. 9 shows a mask for use with the process described in connection with FIG. 8;

FIG. 10 is a flow chart showing further details of the manufacturing process shown in FIG. 5;

FIG. 11 is a perspective view of an antenna following the manufacturing process described in connection with FIG. 8;

FIG. 12 is a flow chart showing further details of the manufacturing process shown in FIG. 5;

FIG. 13 shows a mask for use with the process described in connection with FIG. 12;

FIG. 14 shows the masks of FIGS. 7 and 13 overlaid over one another;

FIG. 15 is a plot of a frequency response of an antenna in accordance with an embodiment of the present invention;

FIG. 16 is a plot of a frequency response of an antenna in accordance with an embodiment of the present invention;

FIG. 17 shows a mask for use with the manufacturing process described hereinafter; and

FIG. 18 shows a mask for use with the manufacturing process described hereinafter.

### DETAILED DESCRIPTION OF THE DRAWINGS

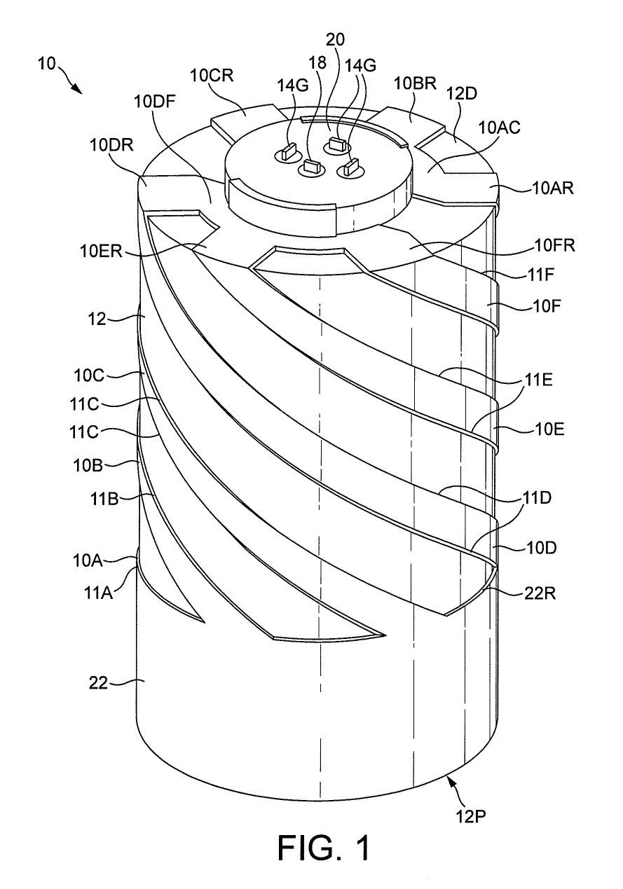

Referring to FIG. 1, a hexafilar helical antenna 10 in accordance with the invention has an antenna element structure with six elongate axially coextensive helical antenna elements 10A, 10B, 10C, 10D, 10E, 10F formed on the cylindrical outer surface of a cylindrical core 12. Each antenna element 10A, 10B, 10C, 10D, 10E, 10F is formed from two layers of conductive material. In particular, each antenna element includes an inner conductive layer and an outer conductive layer. In FIG. 1, only the outer conductive layer of each antenna element can be seen. The inner conductive layer of each antenna element extends under substantially all of the respective outer conductive layer, such that the inner and outer layers are substantially identical in terms of the portions of the antenna core 12 surface which they cover. The inner and outer layers of each antenna element 10A, 10B, 10C, 10D, 10E, 10F are insulated from each other by a layer of insulator 11A, 11B, 11C, 11D, 11E, 11F, which is deposited on the outer surface of the inner conductive layer during the manufacturing process. As a result of the manufacturing process, the layer of insulator extends beyond the outer edge of the inner conductive layer, such that when the outer conductive layer is formed over the layer of insulator, a thin line of the layer of insulator can be seen along the edge of each antenna element 10A, 10B, 10C, 10D, 10E, 10F. This is shown in FIG. 1. Each antenna element 10A, 10B, 10C, 10D, 10E, 10F of the antenna 10 therefore has two electrical paths. Further details of the structure of the antenna elements 10A, 10B, 10C, 10D, 10E, 10F and the method of manufacture of the antenna are provided below.

The core is made of a ceramic material. In this case it is a barium titanate material having a relative dielectric constant of in the region of 36. This material is noted for its dimensional and electrical stability with varying temperature. For this type of material, dielectric loss is exceptionally low. In this embodiment, the core has a diameter of 10 mm. The length of the core is greater than the diameter but, in other embodiments of the invention, it may be less. The core is produced by pressing, but may be produced in an extrusion process, the core then being fired in a furnace.

This preferred antenna is a backfire helical antenna in that it has a coaxial transmission line housed in an axial bore (not shown) that passes through the core from a distal end face 12D to a proximal end face 12P of the core. Both end faces 12D, 12P are planar and perpendicular to the central axis of the core. They are oppositely directed, in that one is directed distally and the other proximally in this embodiment of the invention. The coaxial transmission line is a rigid coaxial feeder which is housed centrally in the bore with the outer shield conductor spaced from the wall of the bore 12B so that there is, effectively, a dielectric layer between the shield conductor and the material of the core 12.

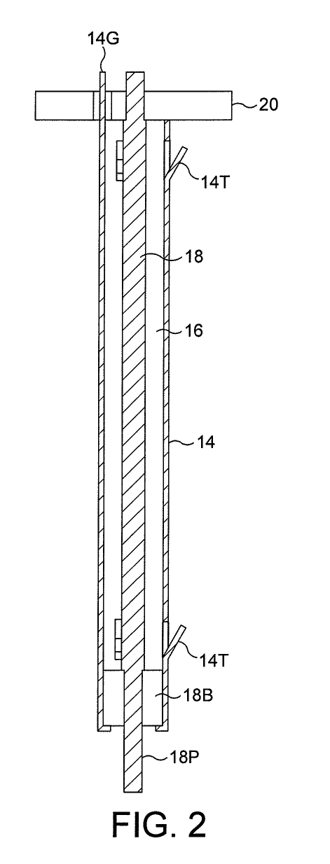

Referring to FIG. 2, the coaxial transmission line feeder has a conductive tubular outer shield 14, a first tubular air gap or insulating layer 16, and an elongate inner conductor 18 which is insulated from the shield by the insulating layer 16. The shield 14 has outwardly projecting and integrally formed spring tangs 14T or spacers which space the shield from the walls of the bore. A second tubular air gap exists between the shield 14 and the wall of the bore. The insulative layer 16 may, instead, be formed as a plastic sleeve, as may the layer between the shield 14 and the walls of the bore. At the lower, proximal end of the feeder, the inner conductor 18 is centrally located within the shield 14 by an insulative bush 18B. The combination of the shield 14, inner conductor 18 and insulative layer 16 constitutes a transmission line of predetermined characteristic impedance, here 50 ohms, passing through the antenna core 12 for coupling distal ends of the antenna elements 10A to 10F to radio frequency (RF) circuitry of equipment to which the antenna is to be connected. The couplings between the antenna elements 10A to 10F and the feeder are made via conductive connection portions associated with the helical tracks 10A to 10F, these connection portions being formed as radial tracks 10AR, 10BR, 10CR, 10DR, 10ER, 10FR, plated on the distal end face 12D of the core 12. Each connection portion extends from a distal end of the respective helical track to one of two arcuate conductors 10AC, 10DF plated on the core distal face 12D adjacent the end of the bore.

The two arcuate conductors 10AC, 10DF are connected, respectively, to the shield and inner conductors 14, 18 by conductors on a laminate board 20 secured to the core distal face 12D The coaxial transmission line feeder and the laminate board 20 together comprise a unitary feed structure.

Referring to FIG. 2, the inner conductor 18 of the transmission line feeder has a proximal portion 18P which projects as a pin from the proximal face 12P of the core 12 for connection to the equipment circuitry. Similarly, integral lugs (not shown) on the proximal end of the shield 14 project beyond the core proximal face 12P for making a connection with the equipment circuitry ground.

The proximal ends of the antenna elements 1OA-1OF are connected to a rim 22R of a common virtual ground conductor 22. In this embodiment, the common conductor is annular and in the form of a plated sleeve surrounding a proximal end portion of the core 12. This sleeve 22 is, in turn, connected to the shield conductor 14 of the feeder by a plated conductive covering (not shown) of the proximal end face 12P of the core 12.

The six helical antenna elements 10A-10F constitute three pairs 10A, 10D; 10B, 10E; 10C; 10F of such elements, each pair having one helical element coupled to one of the arcuate conductors 10AC, 10DF and another element coupled to the other of the arcuate conductors 10DF, 10AC, and thence, respectively, to the inner conductor 18 and shield 14 of the transmission line feeder. In effect, therefore, the six helical antenna elements 10A-10F may be regarded as being arranged in two groups of three 10A-10C, 10D-10F, all of the elements 10A-10C of one group being coupled to the first arcuate conductor 10AC and all of the elements 10D-10F of the other group being coupled to the second arcuate conductor 10DF. Thus, the two arcuate conductors constitute first and second coupling nodes that interconnect the respective helical antenna elements, and provide common connections for the elements of each group to one or other of the conductors of the transmission line feeder.

The conductive sleeve 22, the plating on the proximal end face 12P of the core, and the outer shield 14 of the feeder together form a quarterwave balun that provides common-mode isolation of the radiating antenna element structure from the equipment to which the antenna is connected when installed when the antenna is operated at its operating frequency. Currents in the sleeve are, therefore, confined to the sleeve rim 22R. Accordingly, at the operating frequency, the rim 22R of the sleeve 22 and the helical elements of each pair 10A, 10D-10C, 10F form a respective conductive loop connected to a balanced feed, currents travelling between the elements of each pair via the rim 22R.

Further details of the feed structure will now be described. The feed structure comprises the combination of a coaxial 50 ohm line 14, 16, 18 and the planar laminate board 20 connected to a distal end of the line. The laminate board 20 is a multiple-layer printed circuit board (PCB) that lies flat against the distal end face 12D of the core 12 in face-to-face contact. The largest dimension of the PCB 20 is smaller than the diameter of the core 12 so that the PCB 20 is fully within the periphery of the distal end face 12D of the core 12, as shown in FIG. 1.

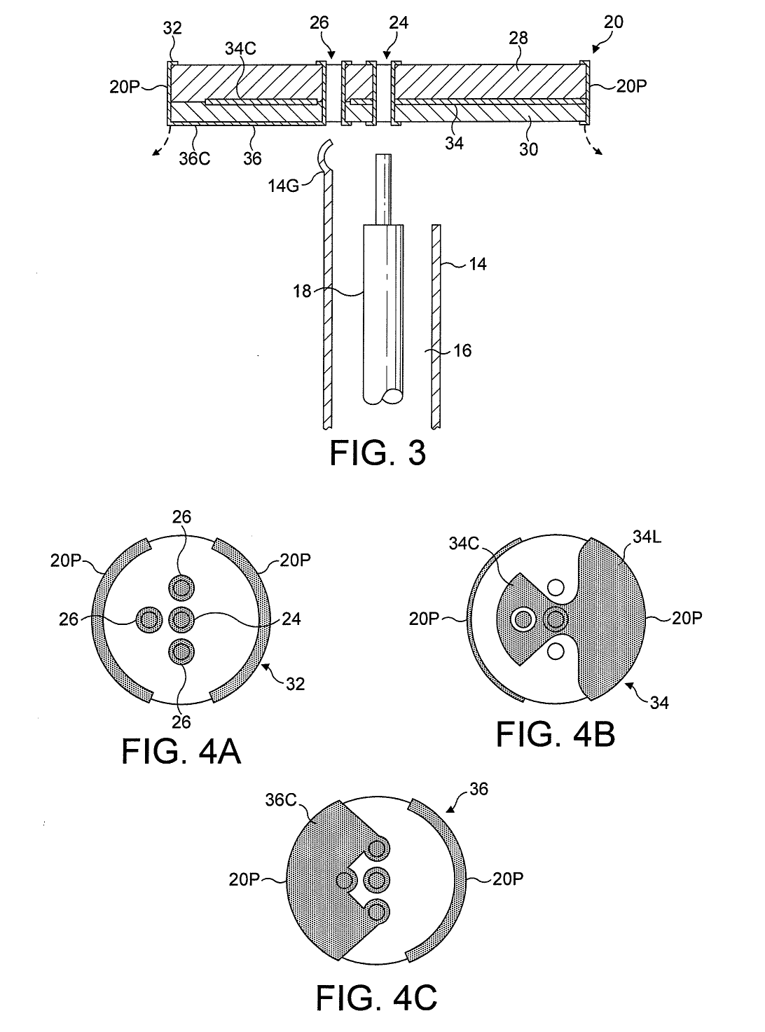

In this embodiment, the PCB 20 is in the form of a disc centrally located on the distal face 12D of the core. Its diameter is such that it overlies the arcuate inter-element coupling conductors 10AC, 10DF plated on the core distal face 12D. As shown in FIG. 3, the PCB has a substantially central hole 24 which receives the inner conductor 18 of the coaxial feeder transmission line. Three off-center holes 26 receive distal lugs 14G of the shield 14. Lugs 14G are bent or “jogged” to assist in locating the PCB 20 with respect to the coaxial feeder structure. All four holes are plated through. In addition, portions 20P of the periphery of the PCB 20 are plated, the plating extending onto the proximal and distal faces of the board.

The PCB 20 is a multiple-layer board in that it has a plurality of insulative layers and a plurality of conductive layers. In this embodiment, the board has two insulative layers comprising a distal layer 28 and a proximal layer 30. There are three conductor layers as follows: a distal layer 32, an intermediate layer 34, and a proximal layer 36. The intermediate conductor layer 34 is sandwiched between the distal and proximal insulative layers 28, 30, as shown in FIG. 3. Each conductor layer is etched with a respective conductor pattern, as shown in FIGS. 4A to 4C. Where the conductor pattern extends to the peripheral portions 20P of the PCB 20 and to the plated-through holes 24, 26, the respective conductors in the different layers are interconnected by the edge plating and the hole plating respectively. As will be seen from the drawings showing the conductor patterns of the conductor layers 32, 34 and 36, the intermediate layer 34 has a first conductor area 34C in the shape of a fan or sector extending radially from a connection to the inner conductor 18 (when seated in hole 24) in the direction of the radial antenna element connection portions 1OAR-10CR. Directly beneath this conductive area 34C, the proximal conductor layer 36 has a generally sector-shaped area 36C extending from a connection with the shield 14 of the feeder (when received in plated via 26) to the board periphery 20P overlying the arcuate or part-annular track 10AC interconnecting the radial connection elements 1OAR-10CR. In this way, a shunt capacitor is formed between the inner feeder conductor 18 and the feeder shield 14, the material of the proximal insulative layer 30 acting as the capacitor dielectric. This material typically has a dielectric constant greater than 5.

The conductor pattern of the intermediate conductive layer 34 is such that it has a second conductor area 34L extending from the connection with the inner feeder conductor 18 to the second plated outer periphery 20P so as to overlie the arcuate or part-annular track 10DF. There is no corresponding underlying conductive area in the conductor layer 36. The conductive area 34L between the central hole 24 and the plated peripheral portion 20P overlying the arcuate track 1ODF acts as a series inductance between the inner conductor 18 of the feeder and one of the groups of helical antenna elements 1OD-1OF.

When the combination of the PCB 20 and the elongate feeder 14-18 is mounted to the core 12 with the proximal face of the PCB 20 in contact with the distal face 12D of the core, aligned over the arcuate interconnection elements 1OAC and 1ODF as described above, connections are made between the peripheral portions 20P and the underlying tracks on the core distal face 12D to form a reactive matching circuit having a shunt capacitance and a series inductance.

The proximal insulative layer of the PCB 20 is formed of a ceramic-loaded plastic material to yield a relative dielectric constant for the layer 30 in the region of 10. The distal insulative layer 28 can be made of the same material or one having a lower dielectric constant, e.g. FR-4 epoxy board. The thickness of the proximal layer 30 is much less than that of the distal layer 28. Indeed, the distal layer 36 may act as a support for the proximal layer 38.

Connections between the feeder line 14-18, the PCB 20 and the conductive tracks on the distal face 12D of the core are made by soldering or by bonding with conductive glue. The feeder 14-18 and the PCB 20 together form a unitary feeder structure when the distal end of the inner conductor 18 is soldered in the via 24 of the PCB 20, and the shield lugs 14G in the respective off-center vias 26. The feeder 14-18 and the PCB 20 together form a unitary feed structure with an integral matching network. The shunt capacitance and the series inductance form a matching network between the coaxial transmission line at its distal end and the radiating antenna element structure of the antenna. The shunt capacitance and the series inductance together match the impedance presented by the coaxial line, physically embodied as shield 14, insulative layer 16 and inner conductor 18, when connected at its proximal end to radio frequency circuitry having a 50 ohm termination, this coaxial line impedance being matched to the impedance of the antenna element structure at its operating frequency or frequencies.

As stated above, the feed structure is assembled as a unit before being inserted in the antenna core 12, the laminate board 20 being fastened to the coaxial line 14-18. Forming the feed structure as a single component, including the board 20 as an integral part, substantially reduces the assembly cost of the antenna, in that introduction of the feed structure can be performed in two movements: (i) sliding the unitary feed structure into the bore 12B and (ii) fitting a conductive ferrule or washer around the exposed proximal end portion of the shield 14. The ferrule may be push fit, crimped or soldered onto the shield.

Prior to insertion of the feed structure in the core, solder paste is preferably applied to the connection portions of the antenna element structure on the distal end face 12D of the core 12 and on the plating immediately adjacent the respective ends of the bore 12B. Therefore, after completion of steps (i) and (ii) above, the assembly can be passed through a solder reflow oven or can be subjected to alternative soldering processes such as laser soldering, inductive soldering or hot air soldering as a single soldering step.

Solder bridges formed between (a) conductors on the peripheral and the proximal surfaces of the board 20 and (b) the metallized conductors on the distal face 12D of the core, and the shapes of the conductors themselves, are configured to provide balancing rotational meniscus forces during reflow soldering when the board is correctly orientated on the core.

Referring again to FIG. 1, the inner conductive layer and the outer conductive layer of each antenna element 10A-10F are insulated from each other by a layer of insulator 18A-18F, as noted above. In a preferred embodiment, the layer of insulator is a layer of polyether ether ketone (PEEK). One suitable product is Vitrex™ PEEK™. In particular, as will be seen below, as PEEK is applied using a colloid of PEEK, VICOTE™, which is an aqueous dispersion of PEEK, may be used. In particular, VICOTE™ F817 may be used. Other suitable polymers may be used. It is also possible to use other insulators, such as glass. During manufacture, a layer of PEEK is deposited on the inner conductive layers using electrophoretic deposition. The outer conductive layers are then formed over the PEEK layer. Accordingly, each helical antenna element 10A-10F includes an inner conductive layer, a PEEK layer, and an outer conductive layer. In use, the inner and outer conductive layers form two electrical paths within each antenna element. This arrangement yields two advantages. Firstly, because each antenna element includes twice as much conductor (two conductive layers rather than one) as an antenna element known from a prior art antenna, the efficiency of an antenna in accordance with the invention is improved. This is because the conductive losses in the antenna elements are reduced. Secondly, because two electrical paths are formed within each antenna element, each having a slightly different length, the resulting antenna has at least two different resonant frequencies. This is because the outer conductive layer follows a slightly longer path than the inner conductive layer. Further details of these advantages will be provided below in connection with specific embodiments.

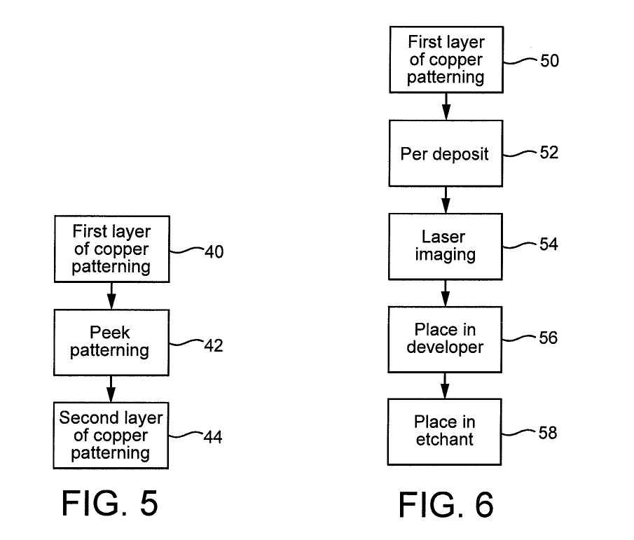

FIG. 5 is a flow diagram which shows the process for manufacturing an antenna in accordance with an embodiment of the present invention. The process includes the steps of plating two layers of copper on the core 12, and depositing a layer of PEEK on the inner conductive layer of each antenna element. The first step is to plate the antenna core 12 with a layer of copper. Copper is plated over the outer surface of the core, and is then removed in certain areas to leave the arcuate conductors 10AC, 10DF, the radial elements, 10AR-10FR, the inner conductive layer of the helical antenna elements 10A-10F, and the conductive sleeve 22 (block 40). The next step is to deposit a patterned layer of PEEK on the inner conductive layer of the helical antenna elements 10A-10F using electrophoretic deposition (block 42). The use of electrophoretic deposition ensures that PEEK is only deposited on exposed parts of the first layer of material, as will be explained in more detail below. Finally, the antenna core 12 is completely plated with a further layer of copper, which is then removed in certain areas, to leave the second conductive layer of each antenna element (block 44) over the layer of PEEK. The antenna 10 produced by this process is shown in FIG. 1. Each of these steps will be described in more detail below.

In an embodiment of the present invention, the process of manufacture uses automated machines, such as pick-and-place machines, to move sets of antennas from one stage of the manufacturing process to the next, and during each individual manufacturing stage. The details of these machines are omitted from this description for the sake of clarity. While each stage of the process will be described in connection with a single antenna, it will be appreciated by one skilled in the art that automated pick-and-place machines enable the process to be applied to several antennas at the same time.

The first stage of the manufacturing process is to form a first layer of copper on the core 12. This process will be described in connection with FIG. 6. The process begins by taking a blank ceramic core 12 from a rack. At this stage in the process, the blank ceramic core 12 has no conductive plating formed on it. The entire ceramic core 12 is placed in a copper bath and is plated with a layer of copper (block 50). In order to do this, the surface of the ceramic is roughened using an etchant. The surface of the ceramic is coated in a catalyst so that the surface may accept an electroless plating process. Once prepared, the ceramic core 12 is placed in the bath of a colloid of copper. The catalyst causes an initial deposit of copper to be formed on the ceramic core. As the layer of copper builds up, it makes contact with an electrode which is connected to the ceramic core. The thin copper surface becomes an anode which then enables a thicker layer of copper to be deposited using electrolytic deposition. The ceramic core 12 is then removed from the plating bath. The next step is to remove the copper plate from certain areas of the core 12, such that copper plating remains in the shape of the artwork shown in FIG. 1. In order to do this, a mask is produced over those areas of the copper plating which are to be kept. The areas which are not covered by the mask will then be removed later in the process.

The mask is produced by first applying a photo-etch resist (PER) deposit over the entire copper surface using electrophoretic deposition (block 52). This is done by placing the copper plated core 12 in a PER colloid. The copper plating on the antenna is connected to a first terminal of a voltage source (not shown), and the container holding the PER colloid is connected to a second terminal of the voltage source. The voltage source then applies a potential difference across the terminals for a predetermined time. The copper is then coated with a layer of the PER by electrophoretic deposition. This process results in the entire copper surface being coated in PER. The coated core 12 is then removed from the PER colloid.

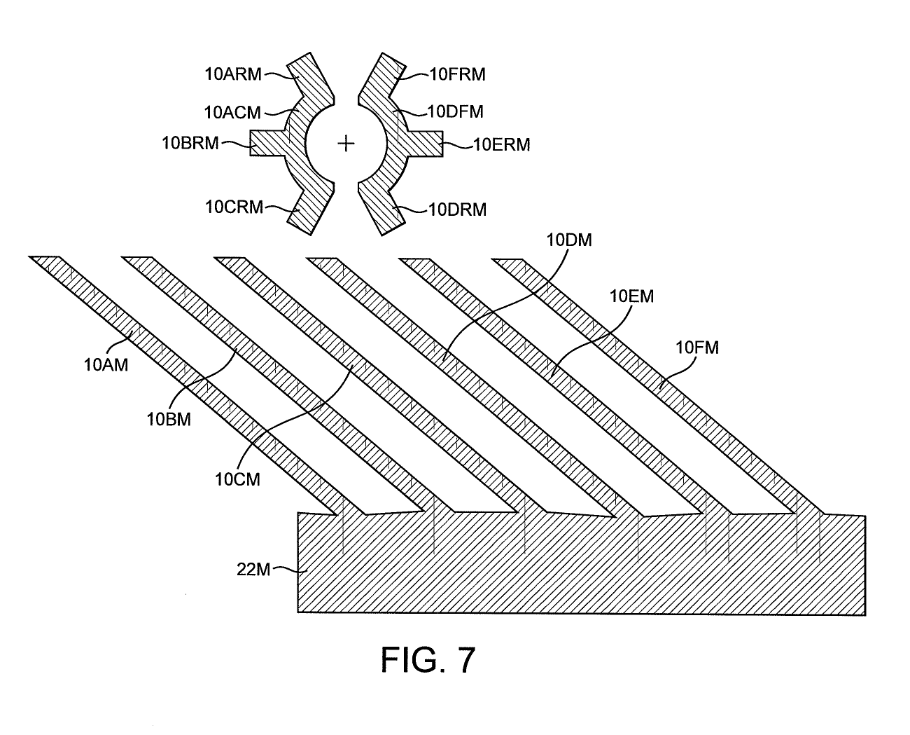

The core 12 is then moved to an exposure chamber where the PER can be exposed using a laser light source to activate certain areas of the PER. The areas of the PER deposit which correspond to areas of copper plate which are to be kept are then exposed using a laser (block 54). This is done using the artwork shown in FIG. 7. The artwork shown in FIG. 7 corresponds to the artwork shown in FIG. 1. The artwork shown in FIG. 7 includes a balun section 22M, antenna element sections 10AM, 10BM, 10CM, 10DM, 10EM, 10FM, radial element sections 10ARM, 10BRM, 10CRM, 10DRM, 10ERM, 10FRM and arcuate element sections 10ACM, 10DFM. The ceramic core 12, including the copper plate and PER deposit layer, is exposed to laser light using the laser in the areas of the artwork. This exposes the PER in the areas shown in FIG. 7. When the PER is exposed to the laser, a photochemical effect occurs within the PER which further polymerises the PER. The ceramic core is then placed in a developing bath (block 56). The developer removes the PER in areas where is has not been exposed to the laser light source, which effectively produces a positive mask of PER over the copper. The ceramics core 12 is then moved to an etching bath (block 58). Here an etchant removes the copper in the areas not covered by the PER. This process results in an antenna having a single layer of copper plate, having a shape similar to the artwork shown in FIG. 1. The above described process is a positive photo-etch process.

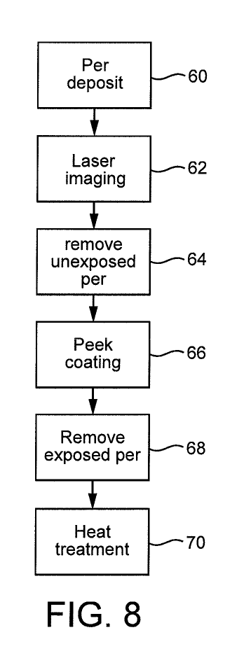

The next stage of the process is to provide a layer of PEEK on the helices 10A-10F and the radial elements 10AR-10FR. This will be described in connection with FIG. 8.

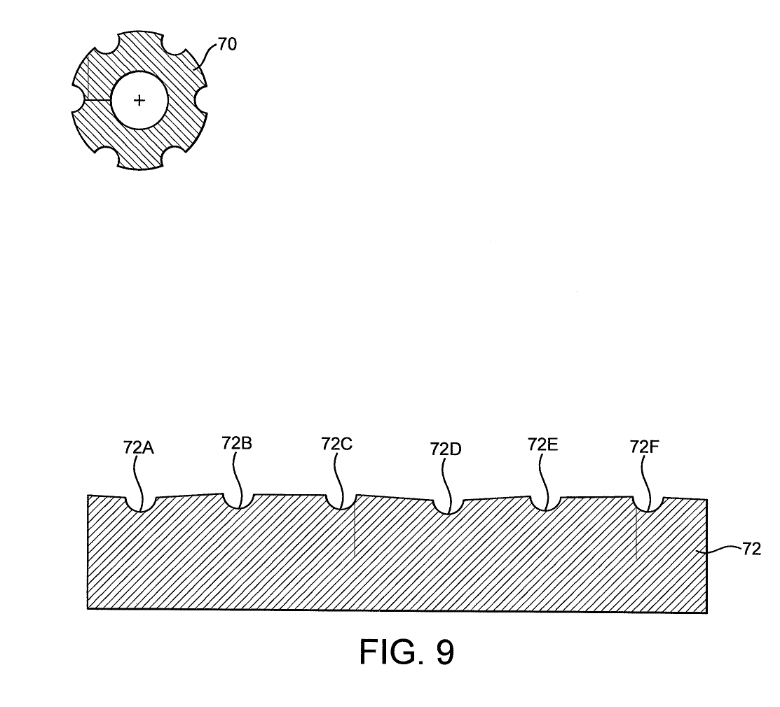

In the finished antenna, a layer of PEEK is only deposited on the inner conductive layer of the antenna elements 10A-10F and to the radial elements 10AR-10 FR. Accordingly, prior to depositing PEEK on the copper, a mask must be applied to the copper plating. This is done in a similar manner to the first stage of the process, by applying a layer of PER to the copper, and exposing the PER in areas where PEEK is not to be deposited. The first step is to coat all of the copper plating with a layer PER using electrophoretic deposition (block 60). The method used here is the same as that used above in connection with the process described in FIG. 6. The next stage is expose the areas of PER which correspond to areas of copper which will not be covered in PEEK (block 62). Again, this is done in the same manner as described in connection with FIG. 6. The artwork showing the areas of PER which will be fixed is shown in FIG. 9. As can be seen in FIG. 9, the artwork includes a top section 70 and a balun section 72. The balun section 72 includes semicircular portions 72A, 72B, 72C, 72D, 72E, 72F which correspond to the points at which the antenna elements 10A-10F are connected to the conductor 22. After exposure to the laser light source, the PER in these areas is activated and is made to resist the developer. After laser imaging, the ceramic core 12 is placed in a bath of developer (block 64) in order to remove the PER in the areas which have not been exposed; i.e. along the helical antenna elements 10A-10F and along the radial conductors 10AR-10FR to expose the inner conductive layers of the antenna elements and the radial elements.

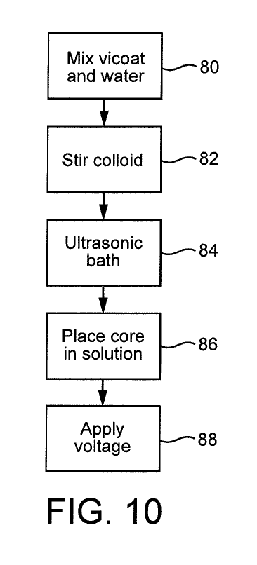

The next stage in the process is to apply PEEK to the exposed copper (block 66). This is done using electrophoretic deposition. The process of depositing PEEK using electrophoretic deposition will be described in connection with FIG. 10.

Prior to coating the first copper layer with PEEK, an appropriate colloid of PEEK must be prepared. This is done by mixing a suitable quantity of a suspension of Vicote™ (product number F817—supplied by Vitrex™) to distilled water (block 80). The resulting colloid should be such that it contains about 5% of PEEK by weight. The applicant has found that a 30 ml suspension of Vicote™ added to 200 ml of distilled water provides a suitable colloid. The colloid is then stirred for 30 minutes (block 82). The container holding the solution is then put in an ultrasonic bath for 30 minutes to ensure uniform dispersion of the PEEK particles (block 84). The temperature and pH of the colloid is monitored and adjusted to ensure a temperature of no more than 22° C., and no lower than 16° C., and a pH of around 9.5. Following this process, the colloid is ready for deposition.

The antenna core 12 is placed in a cell (block 86). The cell is a cylindrical container about 40 mm across and 80 mm deep, which is made of PTFE (polytetrafluoroethylene), and coated with copper. The copper plated cell itself is connected a first terminal of a voltage source, and the copper on the antenna is connected a second terminal of the voltage source (block 88). Zero volts is applied to the first terminal and +15V is applied to the second terminal. This causes a current of about 10 mA, which is applied for about 5 to 7 seconds. The PEEK particles have a negative charge and are therefore attracted to the exposed copper. A layer of PEEK is deposited on the exposed copper by the process of electrophoresis. This process results in a layer of PEEK having a thickness of somewhere between 20 and 70 micrometers being formed on the exposed copper.

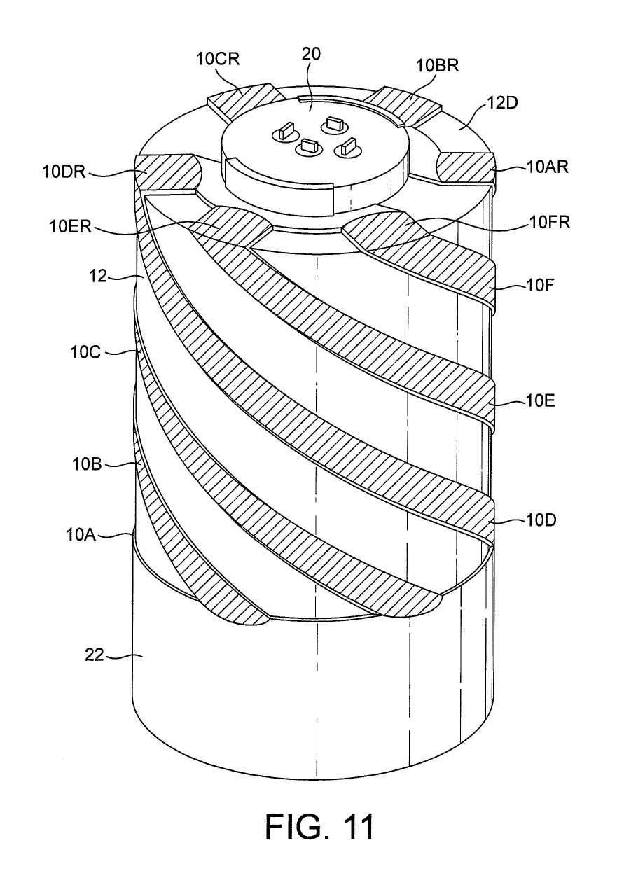

Referring back to FIG. 8, following application of the layer of PEEK, the PER is removed using an etchant (block 68), leaving a PEEK deposit on the areas shown in FIG. 11. As can be seen in FIG. 11, the PEEK coats the inner conductive layers of the antenna elements 10A-10F and the radial elements 10AR-10FR. The core 12 is then heated in a nitrogen furnace to a temperature of about 400° C. for ten minutes (block 70). This causes the PEEK to change from a colloid deposit to a water-impermeable plastic film.

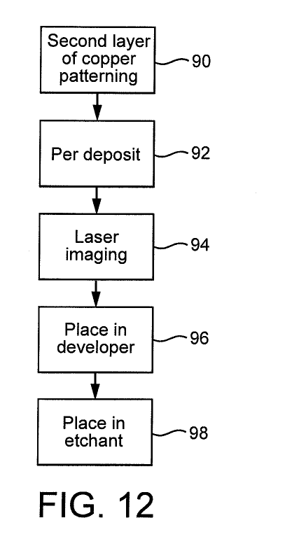

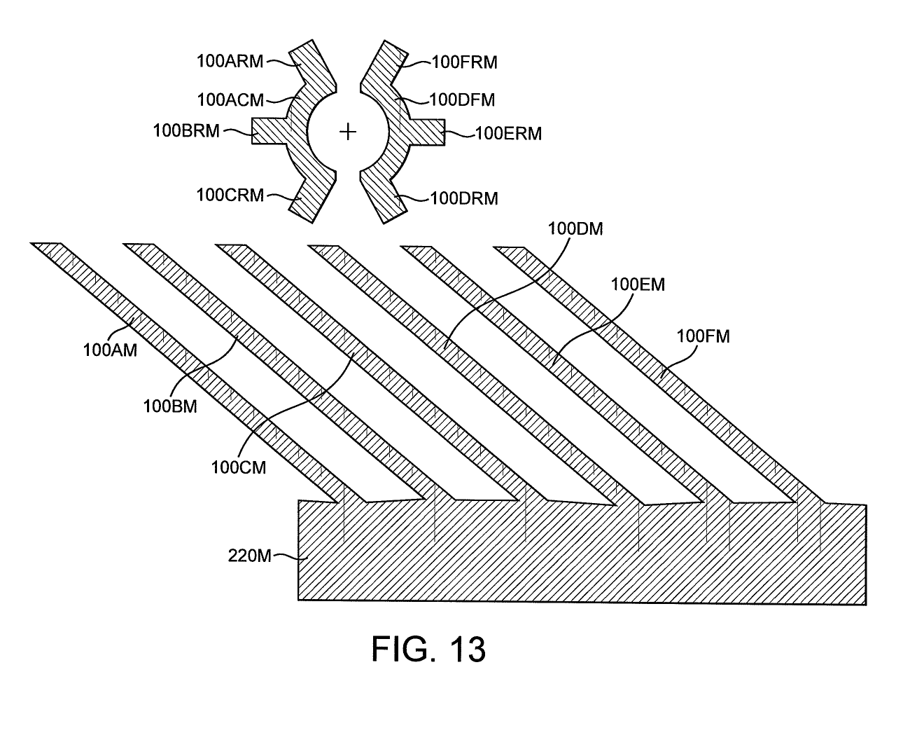

The next stage in the process is to coat a second layer of copper over the first layer of copper plating and the PEEK layer. This process is shown in FIG. 12, and is similar to that described in connection with FIG. 6. Firstly, copper is plated over the entire dielectric core 12 (block 90) by placing the antenna core 12 in a copper bath, using the same process as described above. PER is then applied over the second layer of copper plating using electrophoretic deposition (block 92). The PER is then exposed to laser light with a laser in the areas of the artwork shown in FIG. 13 (block 94). The mask shown in FIG. 13 includes a balun section 220M, helical element sections 100AM, 100BM, 100CM, 100DM, 100EM, 100FM, radial element sections 100ARM, 100BRM, 100CRM, 100DRM, 100ERM, 100FRM, and arcuate element sections 100ACM, 100DFM. The areas of PER which have not been exposed are then removed by placing the ceramic core in a developer bath (block 96). This produces a mask of PER over the second layer of copper. The copper underlying the PER which has not been removed is then stripped (block 96) by placing the ceramic core in an etchant. Accordingly, an additional layer of copper is formed over the existing copper layer, and the PEEK layer. Accordingly, the outer conductive layers of each antenna element 10A-10F and each radial element 10AR-10FR are formed over the PEEK layers 11A-11F. This process completes the formation of the layers of copper and PEEK, and produces an antenna in accordance with a first embodiment, as shown in FIG. 1.

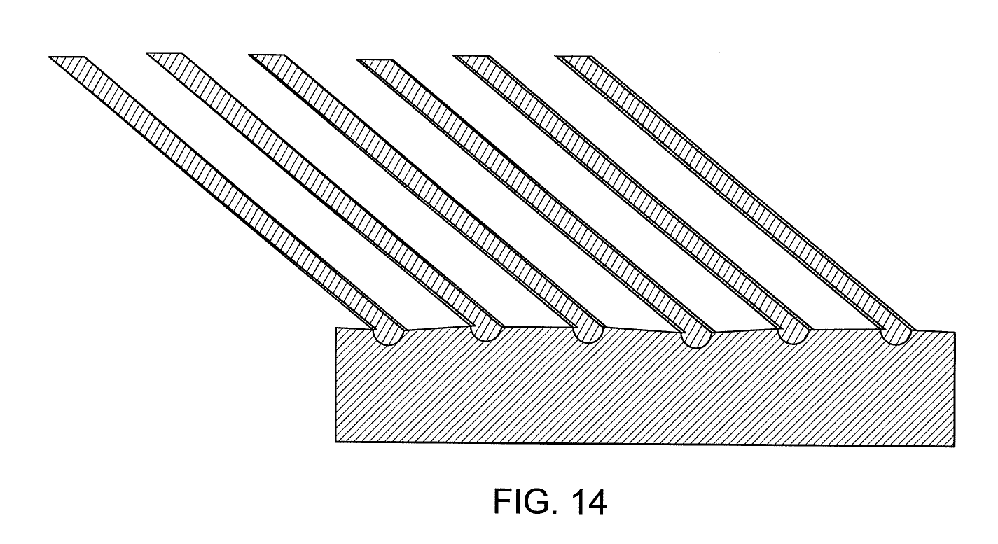

FIG. 14 shows the artwork for the copper and PEEK layers overlaying each other. The pitch angles of the helical sections of the masks are different, because as each layer is deposited on the dielectric core 12, the diameter of the surface on which the next layer is deposited is increased.

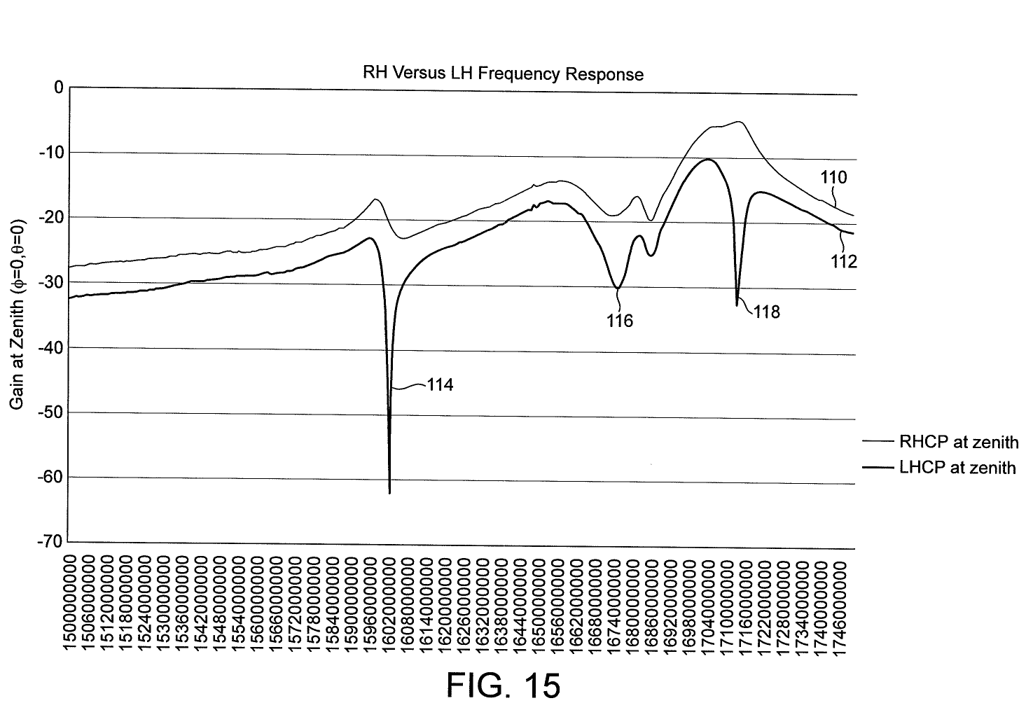

FIG. 15 shows a plot of the frequency response of an antenna 10 in accordance with the above embodiment. In particular, it shows a plot of the antenna's response to right-hand circularly polarised signals (RHCP) 110 and left-hand circularly polarised signals (LHCP) 112. As can be seen, the antenna 10 has a better response to RHCP signals, and the LHCP response includes three main nulls. The first null 114 is at 1.602 GHz, the second null 116 is at 1.674 GHz, and the final null 118 is at 1.713 GHz. The reason for the different nulls in frequency response is due to the introduction of more than one electrical path along each of the helical antenna elements. Electric currents travelling along the length of each of the copper layers in the antenna elements account for the nulls 114 and 118. The middle null 116 is due to the combination both current paths. As each path is isolated from the other, the null 114 and 118 are greater than null 116. This antenna is therefore ideally suited to applications in which a response to two or more frequencies is required.

A second embodiment of the present invention will now be described. In the second embodiment, PEEK is not applied along the entire length of each helical antenna element. Instead, a small gap in the layer of PEEK is provided halfway along each helical antenna element. Accordingly, the inner and outer conductive layers are electrically connected halfway down each antenna element.

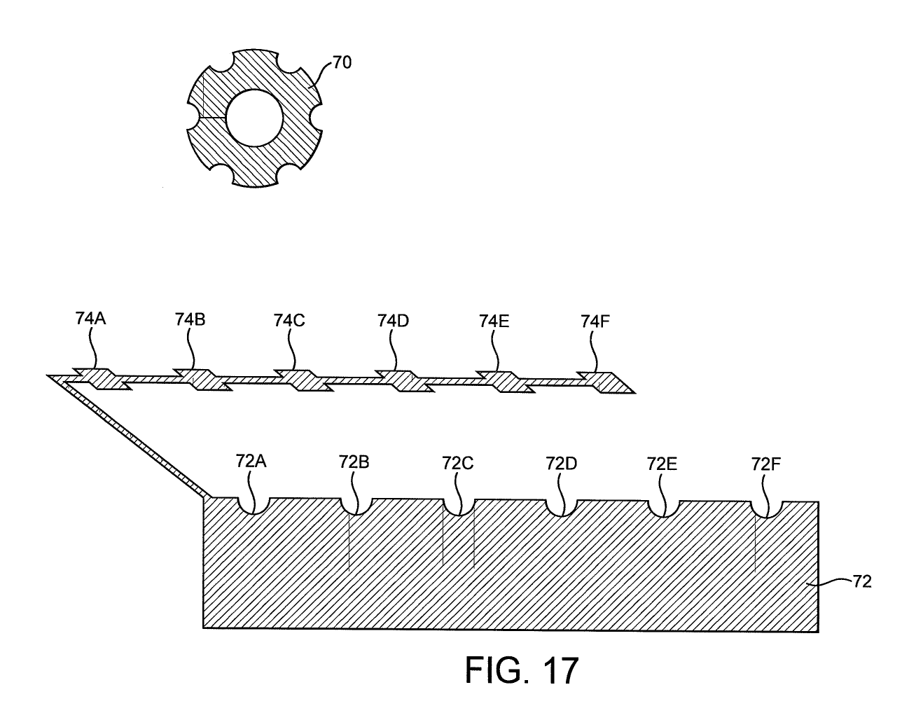

The process for manufacturing an antenna according to the second embodiment is essentially the same as the process for manufacturing an antenna according to the first embodiment. However, the artwork shown in FIG. 17 is used instead of the artwork shown in FIG. 9. The artwork shown in FIG. 17 includes the same top section 70 and a balun section 72 as the artwork shown in FIG. 9. Additionally, the artwork includes intermediate portions 72A, 72B, 72C, 72D, 72E, 72F. Accordingly, a layer of PER remains on the inner conductive layer halfway down each helical antenna element 10A-10F. After the PEEK has been deposited on the exposed part of each antenna element, and the PER removed, a small portion of copper from the first layer remains exposed. After plating the second layer of copper over the PEEK deposit, the inner and outer conductive layers are electrically connected at the midpoint of each antenna element.

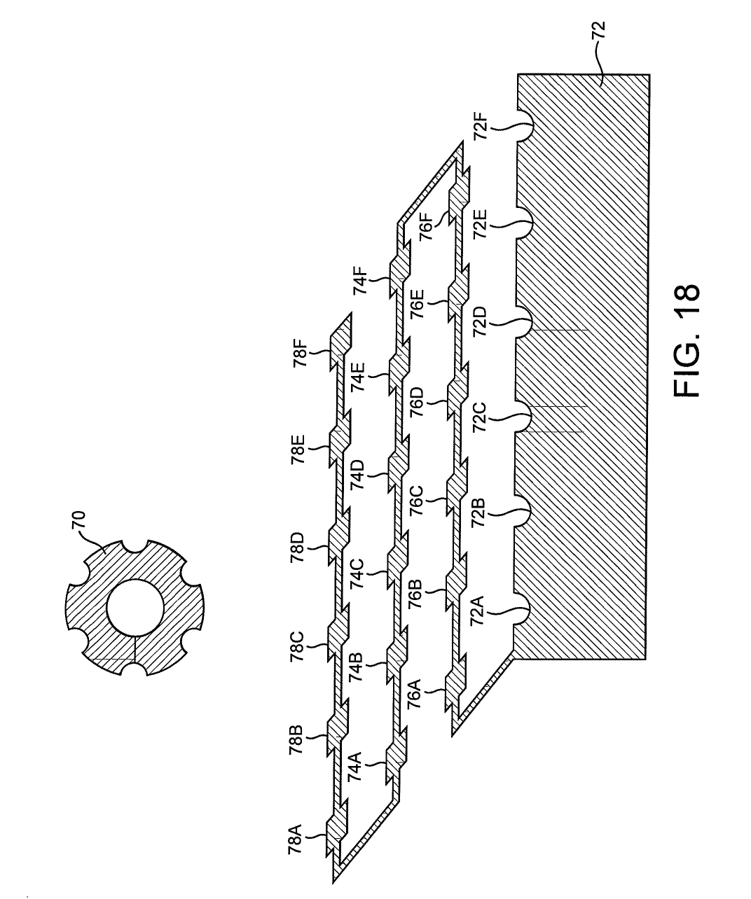

In a third embodiment of the present invention, the artwork shown in FIG. 9 is replaced by the artwork shown in FIG. 18. The process for manufacturing an antenna according to the third embodiment is essentially the same as the process for manufacturing an antenna according to the first and second embodiments. However, the artwork shown in FIG. 18 is used instead of the artwork shown in FIG. 9. The artwork shown in FIG. 18 includes the same top artwork section 70 and a balun section 72 as the artwork shown in FIG. 9. Additionally, the artwork includes middle intermediate portions 74A, 74B, 74C, 74D, 74E, 74F, lower intermediate portions 76A, 76B, 76C, 76D, 76E, 76F, and upper intermediate portions 78A, 78B, 78C, 78D, 78E, 78F. Accordingly, a layer of PER remains on the inner conductive layers at three equally spaced points along each antenna element 10A-10F. After the PEEK has been deposited on the exposed part of each antenna element 10A-10F, and the PER removed, a small portion of copper from the first layer remains exposed at each of the three equally spaced locations. After plating the second layer of copper, the antenna elements 10A-10F formed by the inner and outer conductive layers are electrically connected at the three equally spaced points along each of the antenna elements.

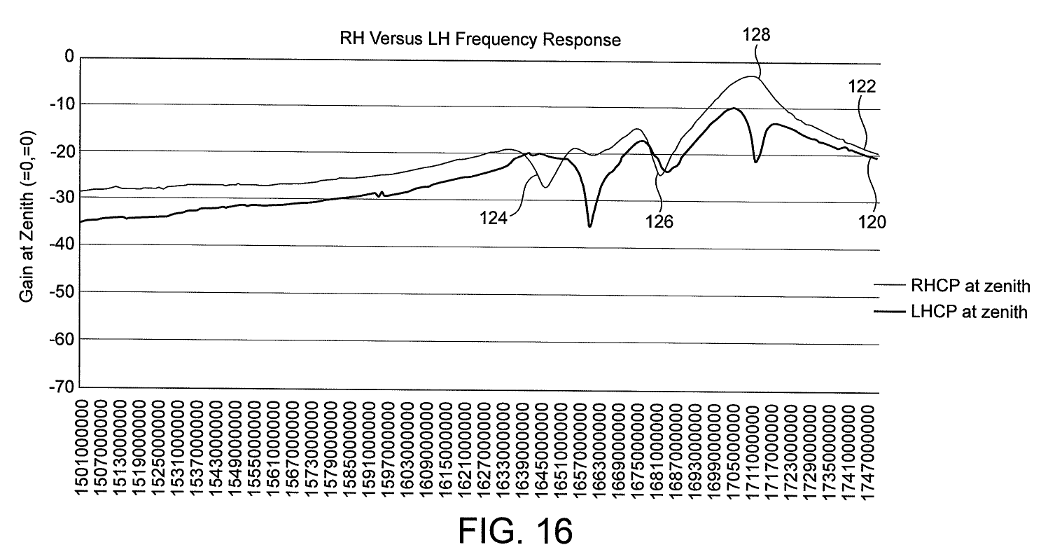

The frequency response of the antenna in accordance with the third embodiment is shown in FIG. 16. The chart shows the LHCP response 120 and the RHCP response 122. In this case, independent modes of resonance (i.e. independent to individual metallization layers) are suppressed and corporate modes of resonance (i.e. involving all layers coherently carrying sympathetic resonance currents) are enhanced. The resonate modes are pulled closer together in frequency, because frequency separation is opposed in a structure which uses interconnections to force coherent corporate resonances. As FIG. 16 shows, suppression of modes has occurred at 1.645 GHz 124 and 1.682 GHz 126, and enhancement of the dominant mode has occurred at 1.709 GHz 128. Additionally, the frequency separation between modes has been reduced. An antenna in accordance with this embodiment is ideally suited to applications in which greater efficiencies are required.

In a further embodiment, more than two layers of copper, and more than one layer of PEEK may be formed in each antenna element 10A-10F. For example, four layers of copper, and three layers of PEEK may be provided. An antenna in accordance with such an embodiment has the same two advantages associated with the first three embodiments. In particular, as each helical element contains even more copper than a helical element of the second embodiment, even greater efficiencies are realized. In particular, where the four copper layers are joined as shown in FIGS. 17 and 18, the resulting antenna is particularly suitable for applications where increased efficiency is required. If the copper layers are not joined in this way, such an antenna may have four or more frequencies of resonance.

The above described embodiments relate to a hexafiliar antenna. It will be appreciate that the invention is not limited in application to hexafiliar antennas, and may be applied equally to bifilar, quadrifiliar and octafilar antennas, as well as antennas having any other number of conductive tracks and antenna element arrangements.

While particular combinations of features have been made in the claims, and in the above description, it will be appreciated that various other combinations are technically possible, and those combinations are disclosed by the present application.

Various modifications, changes, and/or alterations may be made to the above described embodiments to provide further embodiments which use the underlying inventive concept, falling within the spirit and/or scope of the invention. Any such further embodiments are intended to be encompassed by the appended claims.

What is claimed is:

1. A method of manufacturing a dielectrically loaded antenna having an operating frequency in excess of 200 MHz, the antenna having an electrically insulative core, the method comprising:
forming a first patterned layer of conductive material having a plurality of inner conductive tracks on at least one surface of the core of the antenna;
depositing a layer of insulative material over at least a portion of the first layer of conductive material; and
forming a second patterned layer of conductive material having a plurality of outer conductive tracks, at least partially overlapping the inner conductive tracks.

2. A method according to claim 1, wherein the inner and outer conductive tracks are formed as elongate conductive tracks.

3. A method according to claim 2, wherein the inner and outer conductive tracks are formed such that at least one of the outer tracks is in registry with a respective one of the inner conductive tracks.

3. A method according to claim 1, wherein the insulative material is deposited over the first layer of conductive material so as to electrically insulate at least one of said inner conductive tracks from a respective outer conductive track over at least a portion of respective overlapping areas therebetween.

4. A method according to claim 3, wherein said first layer of conductive material includes at least one inner coupling portion electrically connected to said inner conductive tracks, said second layer of conductive material includes at least one outer coupling portion electrically connected to said outer conductive tracks and overlaying and in registry with said at least one inner coupling portion, and said layer of insulative material is formed such that the at least one inner coupling portion and the at least one outer coupling portion are in electrical contact with each other.

5. A method according to claim 3, further comprising patterning the layer of insulative material to leave at least one intermediate portion of the inner conductive tracks exposed, such that when the respective outer conductive tracks are formed over the inner conductive tracks, corresponding intermediate portions thereof are formed directly on the intermediate portions of the inner tracks to make electrical contact therewith.

6. A method according to claim 1, wherein the core is cylindrical, and the inner and outer conductive tracks are formed on a cylindrical outer surface of the core.

7. A method according to claim 6, wherein the inner and outer conductive tracks are formed as helical tracks.

8. A method according to claim 1, wherein said layer of insulative material is deposited on said first conductive layer using electrophoretic deposition.

9. A method according to claim 8, wherein said step of depositing said layer of insulative material comprises: placing said antenna in a colloid of said insulative material.

10. A method according to claim 8, further comprising: applying a layer of photo-processable resist over portions of the first conductive layer to define the portions of the first conductive layer over which the layer of insulative material is to be deposited, wherein the layer of insulative material is deposited over the first conductive layer on the portions of the first conductive layer where no photo-processable resist has been applied.

11. A method according to claim 10, further comprising: applying said photo-processable resist to said first layer of conductive material using electrophoretic deposition.

12. A method according to claim 11, further comprising: fixing said photo-processable resist over said portions of the first conductive layer using a laser light source, using a first mask, wherein the first mask defines the areas of the photo-processable resist to be fixed.

13. A method according to claim 12, wherein said step of forming the first layer of conductive material includes: plating the core with said conductive material, and removing at least a portion of the conductive material, to leave the first patterned layer of conductive material.

14. A method according to claim 13, further comprising: applying a layer of photo-etch resist over portions of the plated core to define the first patterned layer of conductive material, wherein conductive material is removed from areas of the core where no photo-etch resist has been applied.

15. A method according to claim 14, further comprising: applying said photo-etch resist to said plated core using electrophoretic deposition.

16. A method according to claim 15, further comprising: fixing said photo-etch resist over said portions of the plated core, using a laser light source, using a second mask, wherein the second mask defines the areas of the photo-etch resist to be fixed.

17. A method according to claim 16, wherein said step of forming the second layer of conductive material includes: plating the core with said conductive material, and removing at least a portion of the conductive material, to leave the second patterned layer of conductive material.

18. A method according to claim 17, further comprising: applying a layer of photo-etch resist over portions of the plated core to define the second patterned layer of conductive material, wherein conductive material is removed from areas of the core where no photo-etch resist has been applied.

19. A method according to claim 18, further comprising: applying said photo-etch resist to said plated core using electrophoretic deposition.

20. A method according to claim 19, further comprising: fixing said photo-etch resist over said portions of the plated core, using a laser light source, using a third mask, wherein the third mask defines the areas of the photo-etch resist to be fixed.

21. A method according to claim 20, wherein said masks define elongate helical tracks, and the pitch angle of the helical tracks of the third mask is less than the pitch angle of the helical tracks of the second mask.

22. A method according to claim 1, wherein the insulative material is polyether ether ketone and the conductive material is copper.

23. An antenna formed in accordance with claim 1.

24. A dielectrically loaded antenna having an operating frequency in excess of 200 MHz, the antenna having an electrically insulative core and an antenna element structure overlaying at least one surface of the core, the antenna element structure including a first patterned layer of conductive material having a plurality of inner conductive tracks, a layer of insulative material deposited over at least a portion of the first layer of conductive material, and a second patterned layer of conductive material, having a plurality of outer conductive tracks, at least partially overlapping the inner conductive tracks.

25. An antenna according to claim 24, wherein the inner and outer conductive tracks are formed as elongate conductive tracks.

26. An antenna according to claim 25, wherein the inner and outer conductive tracks are formed such that at least one of the outer tracks is in registry with a respective one of the inner conductive tracks.

27. An antenna according to claim 24, wherein the insulative material is deposited over the first layer of conductive material so as to electrically insulate at least one of said inner conductive tracks from a respective outer conductive track over at least a portion of respective overlapping areas therebetween.

28. An antenna according to claim 24, wherein the inner and outer conductive tracks are coupled to a feed structure.

29. An antenna according to claim 24, wherein the core is an electrical insulator having a relative dielectric constant greater than 5.

30. An antenna according to claim 29, wherein the core is a cylinder and the inner and outer conductive tracks are in the form of helical conductive tracks extending over a cylindrical surface of the core.

31. An antenna according to claim 30, wherein the inner and outer conductive tracks are equally spaced around the cylindrical surface of the core.

32. An antenna according to claim 24, wherein the layer of insulative material is formed such that the inner conductive tracks are electrically insulated from respective outer conductive tracks along at least a portion of overlapping areas therebetween.

33. An antenna according to claim 32, wherein the layer of insulative material is formed over said inner conductive tracks so as to include gaps at intermediate positions, allowing the inner and outer conductors to form electrical connections at said intermediate positions.
